(19) United States
(12) Patent Application Publication
(10) Pub. No.: US 2023/0043167 A1
(43) Pub. Date: Feb. 9, 2023

(54) PBT-BASED COMPOSITION

(71) Applicant: BASF SE, Ludwigshafen (DE)

(72) Inventors: Jin Huang, Shanghai (CN); Hang Lu, Shanghai (CN); Roland Helmut Kraemer, Lemfoerde (DE); Tao Liu, Shanghai (CN); Martin Weber, Ludwigshaten (DE)

(21) Appl. No.: 17/793,096

(22) PCT Filed: Jan. 8, 2021
(86) PCT No.: PCT/EP2021/050256

§ 371 Date: Jul. 15, 2022

(30) Foreign Application Priority Data
Jan. 21, 2020 (CN) PC/CN2020/073551

(51) Int. Cl. C08L 23/12; C08L 23/26; C08L 67/02; H01M 50/121

(52) U.S. Cl. CPC C08L 23/12; C08L 23/26; C08L 67/02; H01M 50/121; C08L 2205/02

(57) ABSTRACT

The invention relates to a poly(butylene terephthalate) (PBT)-based composition, comprising a) PBT, and b) another thermoplastic polymer from the group consisting of polypropylene (PP), and/or at least one polyester which is selected from the group consisting of liquid crystal polyester (LCP), poly(ethylene terephthalate) (PET) including low melting point polyester, poly(butylene naphthalate) (PBN) and poly(ethylene naphthalate) (PEN), to a method for preparing the PBT-based composition, to a use of the PBT-based composition according to the invention in increasing electrolyte resistance, in particular in battery applications, especially in Li-ion batteries, and to an article obtained from the PBT-based composition according to the invention.

### FIELD OF THE INVENTION

The invention relates to an article as battery component, a poly(butylene terephthalate) (PBT)-based composition, a method for preparing the PBT-based composition, a use of the PBT-based composition in increasing electrolyte resistance.

### BACKGROUND OF THE INVENTION

With the fast development of new electric vehicles (NEV), Li-ion batteries are required for higher energy density, lighter weight, and longer life span. Considering light battery weight, low electrolyte permeation, high seal-strength properties as well as cost competitiveness, aluminum alloy-based prismatic battery cans/lids or multilayer-laminated films for the pouch battery (e.g. aluminum- and polypropylene-based) are the most widely used packaging materials which have direct contact to the electrolyte solutions in the existing battery designs.

CN 101159320 (A) discloses a laminate for battery package material comprising protection layer, aluminum layer, adhesive layer and internal layer. The aluminum layer is surface treated by metal phosphate salt or the mixture of non-metal phosphate salt and aqueous synthetic resin to improve bonding with adhesive layer. The internal layer is made by co-extruding unsaturated carboxylic acid grafted polyolefin resin. The layers are integrated into the battery package. However, the manufacturing process of multilayer laminate is too complicated.

CN 102431239 (A) discloses a battery cell package with good barrier property and electrolyte resistance. The battery cell package comprises a co-extruded multilayer film which consists of an outer barrier, barrier layer and high barrier laminate, wherein said outer barrier is at least one selected from PET, BOPA and PEN, or co-extruded layer thereof; said barrier layer is aluminum foil containing 0.9 wt %-1.5 wt % of Fe; the high barrier laminate comprising a base layer, functional layer and heat seal layer. The electrolyte resistance of the package relies on the laminate structure of the materials.

CN106505170 (A) discloses a battery cell for a lithium-ion power and energy storage battery made of polymer materials which are selected from one or more blends of polymers containing phenyl sulfide group (e.g. polyphenylene sulfide), polyphenyl ether, polyether ether ketone, polysulfone, polyimide, polyaromatic ester, polystyrene (e.g. syndiotactic polystyrene), polyester (e.g. PET, PBT, PCT), polyamide (e.g. aromatic polyamides), polyolefins or their copolymers (e.g. polypropylene, polyethylene, ethylene/alpha-olefin copolymers (e.g. ethylene-octene copolymers), propylene/alpha-olefin copolymers (e.g. propylene-ethylene copolymers)), epoxy vinyl ester resins, phenolic epoxy vinyl ester resins, chlorinated unsaturated polyester resins, polytetrafluoroethylene, polyvinylidene fluoride, etc. The cell housing and the upper cover of the battery cell are prepared from said polymer materials, so that the corrosive effect of a lithium-ion battery electrolyte on the battery cell can be effectively prevented. However, it was only demonstrated PPS, PPS/PP, SPS, chlorinated polyester could afford the electrolyte solution at room temperature for 240 hours, the test time is much shorter than the lifetime of the battery.

PBT, as one of the most popular engineering plastics, has been developed for various applications in different industries such as Electric & Electrical, transportation etc. in the last decades since it features high rigidity and strength, good dimensional stability, low water absorption and high resistance to many chemicals.

However, PBT itself cannot survive in the electrolyte solutions consisting of different carbonate-based solvents as well as other additives such as LiPFs, proven by the poor retention of tensile strength after immersing PBT in the electrolyte solution at the working temperature of up to 85° C. for 240 hours.

Therefore, there is still a need to find a novel material to improve the retention of mechanical properties, such as tensile strength (preferably >80%) and/or E-Modulus after immersing the material into the electrolyte solutions at high working temperature.

### SUMMARY OF THE INVENTION

The present invention provides an article as battery component, which is obtained from a PBT-based composition, comprising a) poly(butylene terephthalate), and b) another thermoplastic polymer. The article or battery component is preferably selected from the group consisting of package, housing, main body of package or housing, cover, cap and busbar of battery cell, battery module and battery pack. The battery is preferably Li-ion battery.

The present invention provides a method of improving electrolyte resistance, comprising applying the PBT-based composition to battery component, preferably Li-ion battery component.

The present invention provides a use of the PBT-based composition according to the invention in increasing electrolyte resistance, in particular in the battery components. The battery component is preferably selected from the group consisting of package, housing, main body of package or housing, main body of package or housing, cover, cap and busbar of battery cell, battery module and battery pack. The battery is preferably Li-ion battery.

The present invention provides a PBT-based composition, comprising a) PBT, and b) another thermoplastic polymer.

The present invention provides a method for preparing the PBT-based composition according to the invention.

The present invention provides a method for preparing a package or housing of battery cell, comprising: (1) injection molding a main body of the package or housing having walls and one bottom, and a cap or cover, respectively, (2) binding the main body with the cap or the cover by laser welding. The main body could have four walls for cuboid package or housing, one wall for cylinder package or housing. The walls and the bottom could be injection molded into one piece, or injected molded separately, and banded together by laser welding.

### DETAILED DESCRIPTION OF THE INVENTION

Unless defined otherwise, all technical and scientific terms used herein have the same meaning as commonly understood by one skilled person in the art to which this invention belongs.

Expressions “a”, “an”, “the”, when used to define a term, include both the plural and singular forms of the term.

The term “glycol” is an aliphatic diol containing two hydroxyl groups (—OH groups) attached to different carbon atoms.

The “package” and “housing” means the shell of the battery cell, battery module and battery pack.

In the present invention, the package or housing includes main body of the shell and cap or cover of the shell. The main body usually comprises at least one wall and a bottom, e.g. comprises four walls and one bottom for cuboid battery cell and one wall and one bottom for cylinder battery cell.

The package or housing in the present invention could also be one-piece shell including wall(s), cover or cap, and bottom.

For clarity, it should be noted that the scope of the present invention encompasses all the definitions and parameters mentioned hereinafter in general terms or specified within areas of preference, in any desired combinations. In addition, for clarity, it should be noted that the PBT-based composition, in a preferred embodiment, may be mixtures of components a), and b), and also blends that can be produced from these mixtures by means of processing operations, preferably by means of at least one mixing or kneading apparatus, but also products that can be produced from these in turn, especially by extrusion or injection molding.

In one aspect, the present invention provides an article as battery component, which is obtained from a PBT-based composition comprising a) poly(butylene terephthalate), and b) another thermoplastic polymer. The article preferably is selected from the group consisting of package, housing, main body of package or housing, cover, cap and busbar of battery cell, battery module and battery pack. The battery is preferably Li-ion battery. The article preferably direct or in-direct contact with the electrolyte of the battery.

In one embodiment of the invention, the battery component is obtained from a PBT-based composition comprises a) from 45% to 85% by weight of poly(butylene terephthalate), and b) from 15% to 55% by weight of another thermoplastic polymer, based on the total weight of the PBT-based composition.

Component a):

The PBT-based composition according to the invention comprises, as component a), preferably from 50% to 80%, more preferably from 55% to 75%, and in particular from 55% to 65% by weight, of poly(butylene terephthalate), based on the total weight of the PBT-based composition.

As component a), poly(butylene terephthalate) may be produced, for example, by polycondensation of a first dicarboxylic acid component comprising at least a terephthalic acid and/or its ester, such as dimethyl terephthalate with a first glycol component comprising at least an alkylene glycol having a carbon number of four (i.e. 1,4-butane diol) and/or the ester derivative thereof.

The poly(butylene terephthalate) may be butylene terephthalate homopolymer or the polymer that may be modified with up to 20 mol % of one or more first dicarboxylic acids other than terephthalic acid and/or one or more first glycol other than 1,4-butanediol. Examples of possible first dicarboxylic acids are aliphatic and cycloaliphatic dicarboxylic acids of up to 20 carbon atoms or aromatic dicarboxylic acids with 1 or 2 aromatic rings, e.g. adipic acid, sebacic acid, cyclohexanedicarboxylic acid, isophthalic acid or naphthalenedicarboxylic acid. Examples of possible first glycol are aliphatic and cycloaliphatic glycols of 2 to 10 carbon atoms, such as ethylene glycol, propylene glycol, 1,6-hexanediol, neopentyl glycol, diethylene glycol and 1,4-bishydroxymethylcyclohexane, as well as bisphenols, substituted bisphenols or their reaction products with alkylene oxides.

It may also assist the improvement of the properties if small amounts (such as up to 5% by weight) of trifunctional and polyfunctional crosslinking substances such as trimethylolpropane or trimesic acid are present as co-condensed units in the poly(butylene terephthalate).

The viscosity number of component a) is generally in the range from 80 cm³/g to 160 cm³/g, preferably from 85 cm³/g to 150 cm³/g, in particular from 90 cm³/g to 140 cm³/g, and especially from 120 cm³/g to 135 cm³/g, measured in a 60/40 (by weight) phenol/1,1,2,2-tetrachloroethane solution, according to ISO 307, 1157, 1628.

The number-average molar mass molecular weight (Mn) of component a) is generally in the range from 2,000 to 30,000 g/mol, preferably from 5,000 to 28,000 g/mol, in particular from 15,000 to 26,000 g/mol, and especially 21,000 to 24,000 g/mol, measured by means of GPC, PMMA standard, hexafluoroisopropanol and 0.05% trifluoroacetic acid-potassium salt as eluent.

Component b):

The PBT-based composition according to the invention comprises, as component b), preferably from 20% to 50%, more preferably from 25% to 45%, and in particular from 35% to 45% by weight, of another thermoplastic polymer, based on the total weight of the PBT-based composition.

In one embodiment of the invention, the thermoplastic polymer as component b), can be polypropylene (PP), and/or at least one polyester which has a glass transition temperature (Tg) of equal to or higher than 45° C. (measured by DSC), preferably the polyester which has a glass transition temperature (Tg) of equal to or higher than 45° C. (measured by DSC) and a melting temperature (Tm) of equal to or higher than 220° C. (measured by DSC), more preferably the polyester is selected from the group consisting of liquid crystal polyester (LCP), poly(ethylene terephthalate) (PET), including low melting point PET, poly(butylene naphthalate) (PBN) and poly(ethylene naphthalate) (PEN), etc.

In one embodiment of the invention, the PBT-based composition comprises, from 55% to 65% by weight of component a), and from 35% to 45% by weight of the polyester, the polyester is selected from the group consisting of PEN, LCP, PBN and PET.

Polypropylene (PP):

In one preferred embodiment, the PBT-based composition comprises a) from 45% to 85% by weight, preferably from 50% to 75% by weight, and in particular from 55 to 65% by weight, of poly(butylene terephthalate), and b1) from 10% to 40% by weight, preferably from 20% to 40% by weight, and in particular from 26% to 34% by weight, of ungrafted polypropylene homopolymers, copolymers or blends, and b2) from 5% to 20% by weight, preferably from 7% to 13% by weight, and in particular from 9% to 11% by weight, of polypropylene copolymers grafted with ethylenically unsaturated carboxylic acid and/or derivative thereof, based on the total weight of the PBT-based composition.

Polypropylene b1) in the present invention is not limited in crystallization property, type or amount of a terminal group of polypropylenes, intrinsic viscosity, molecular weight, linear or branched structure, type or amount of a polymerization catalyst, and a polymerization method.

As the polypropylene b1), it is possible to use conventional polypropylene. Polypropylene is described for example in Römpp Chemie Lexikon, 9th edition, page 3570 ff., Georg Thieme Verlag, Stuttgart.

Appropriate polypropylene b1) is available commercially. For example, it is also possible to use high-crystallinity PP copolymers, high-impact PP homopolymers, random copolymers, blends of these, and reinforced and filled products too. Preferred for use as polypropylene b1) are Moplen, Adstif, and HiFax grades from BASELL, Sinopec PP grades, and/or BP Chemicals PP grades.

The polypropylene blend b1) comprises polypropylene and other thermoplastics, e.g. other polyolefins for example polyethylene. Preferably, the polypropylene content in the blend is at least 50%, more preferably at least 90%, and in particular preferably 100% by weight. Particular preference is hence given to “pure” polypropylene: that is, the polypropylene is more preferably not used in a blend with other polymers.

The polypropylene copolymer b2) is preferable polypropylene grafted with ethylenically unsaturated carboxylic acid of up to 15 carbon atoms, preferably up to 8 carbon atoms, and/or derivative thereof. The derivative of ethylenically unsaturated carboxylic is its ester and/or acid anhydride.

The ethylenically unsaturated carboxylic acid and/or derivative thereof is preferably selected from the group comprising glycidyl methacrylate (GMA), acrylic acid, methacrylic acid, methyl acrylate, methyl methacrylate, 2-hydroxypropyl methacrylate, butyl acrylate and maleic anhydride, more preferably is glycidyl methacrylate. The ethylenically unsaturated carboxylic acid is preferably in an amount of up to 5% by weight, more preferably from 1% to 3% by weight, of the total weight of polypropylene copolymer.

The number-average molar mass molecular weight (Mn) of polypropylene b1) and polypropylene copolymer b2) is generally in the range from 5,000 to 600,000 g/mol, preferably from 10,000 to 300,000 g/mol, in particular from 15,000 to 100,000 g/mol, and especially 30,000 to 50,000 g/mol, measured by means of GPC.

Liquid Crystal Polyester (LCP):

In one further preferred embodiment of the invention, liquid crystal polyester (LCP), as component b), means a polyester capable of forming an anisotropic melting phase (liquid crystallinity) when molten. This characteristic can be recognized by observing light transmitted through the sample under polarized radiation when a sample of liquid crystal polyester is placed on a hot stage and heated in nitrogen atmosphere, for example.

The liquid crystal polyester may be:

i) a polymer of an aromatic oxycarboxylic acid component;

ii) a polymer of an aromatic dicarboxylic acid component, an aromatic diol component and/or an aliphatic diol component; and

iii) a copolymer of i) and ii).

It is preferable that the liquid crystal polyester is a wholly aromatic polyester prepared without the aliphatic diol component for achieving high strength, high elastic modulus and high heat resistance. The aromatic oxycarboxylic acid component may be an aromatic oxycarboxylic acid such as hydroxy benzoic acid and hydroxy naphthoic acid, or may be alkyl, alkoxy or halogen substitution product of the aromatic oxycarboxylic acid. The aromatic dicarboxylic acid component may be an aromatic dicarboxylic acid such as terephthalic acid, isophthalic acid, diphenyl dicarboxylic acid, naphthalene dicarboxylic acid, diphenylether dicarboxylic acid, diphenoxyethane dicarboxylic acid and diphenylethane dicarboxylic acid, and may be alkyl, alkoxy or halogen substitution product of the aromatic dicarboxylic acid. The aromatic diol component may be an aromatic diol component such as hydroquinone, resorcinol, dioxydiphenyl and naphthalene diol, or may be alkyl, alkoxy or halogen substitution product of the aromatic diol. The aliphatic diol component may be an aliphatic diol such as ethylene glycol, propylene glycol, butane diol and neopentyl glycol.

It is preferable that the liquid crystal polyester is a homopolymer or copolymer of p-hydroxy benzoic acid component, 4,4′-dihydroxy biphenyl component, hydroquinone component, terephthalic acid component and/or isophthalic acid component, a homopolymer or copolymer of p-hydroxy benzoic acid component and 6-hydroxy 2-naphthoic acid component, a homopolymer or copolymer of p-hydroxy benzoic acid component, 6-hydroxy 2-naphthoic acid component, hydroquinone component and terephthalic acid component or the like, for achieving excellent spinnability, high strength, high elastic modulus, and abrasion resistance by high-temperature heat treatment after solid-phase polymerization.

The number-average molar mass molecular weight (Mn) of liquid crystal polyester is generally in the range from 6,000 to 100,000 g/mol, preferably from 10,000 to 60,000 g/mol, measured by means of GPC.

Poly(Ethylene Terephthalate) (PET):

In one further preferred embodiment of the invention, poly(ethylene terephthalate) (PET), as component b), derives from a second glycol component comprising ethylene glycol and a second dicarboxylic acid component comprising terephthalic acid.

The number-average molar mass molecular weight (Mn) of polyethylene terephthalate is generally in the range from 3,000 to 80,000 g/mol, preferably from 10,000 to 30,000 g/mol, measured by means of GPC.

The PET polymer can be obtained by partial substitution of the second dicarboxylic acid component and/or the second glycol component constituting poly(ethylene terephthalate) with a copolymerizable monomer, in which the second dicarboxylic acid component comprising at least terephthalic acid or the ester derivative thereof, the second glycol component comprising at least an alkylene glycol having a carbon number of two or the ester derivative thereof.

The copolymerizable monomer includes one or more selected from a second dicarboxylic acid other than terephthalic acid and/or a second glycol other than ethylene glycol and 1,4-butane diol. The second dicarboxylic acid could be at least one selected from the group consisting of an aliphatic dicarboxylic acid, an alicyclic dicarboxylic acid, an aromatic dicarboxylic acid other than terephthalic acid and their reactive derivatives.

The aliphatic dicarboxylic acid as the second dicarboxylic acid is preferably dicarboxylic acid comprising from 4 to 40 carbon atoms, more preferably from 4 to 24 carbon atoms, from 4 to 14 carbon atoms, or from 4 to 10 carbon atoms. For example, the aliphatic dicarboxylic acid could be succinic acid, glutaric acid, adipic acid, pimelic acid, suberic acid, azelaic acid, sebacic acid, undecane dicarboxylic acid, dodecane dicarboxylic acid, and hexadecane dicarboxylic acid.

The alicyclic dicarboxylic acid as the second dicarboxylic acid is preferably alicyclic dicarboxylic acid comprising at least one carbon backbone selected from the group consisting of cyclohexane, cyclopentane, cyclohexylmethane, dicyclohexylmethane, bis(methylcyclohexyl), more preferably is selected from the group consisting of cis- and trans-cyclopentane-1,3-dicarboxylic acid, cis- and trans-cyclopentane-1,4-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid.

The suitable aromatic dicarboxylic acid as the second dicarboxylic acid is preferably at least one selected from the group consisting of isophthalic acid, naphthalenedicarboxylic acid and diphenyldicarboxylic acid.

The second glycol could be at least one selected from the group consisting of an aliphatic alkane diol excluding ethylene glycol or 1,4-butane diol, polyoxyalkylene glycol, and an aromatic diol.

The aliphatic alkane diol disclosed herein preferably aliphatic alkane diol comprises from 2 to 12, more preferably from 2 to 6 carbon atoms, for example, trimethylene glycol, propylene glycol, neopentyl glycol, hexane diol, octane diol and/or decane diol.

The polyoxyalkylene glycol disclosed herein preferably comprises a plurality of oxyalkylene units of which the carbon atom number is 2 to 4, more preferably is at least one selected from the group consisting of diethylene glycol, dipropylene glycol, ditetramethylene glycol, triethylene glycol, tripropylene glycol, and polytetramethylene glycol.

The aromatic diol disclosed herein preferably comprises from 6 to 14 carbon atoms, more preferably is at least one selected from the group consisting of xylylene glycol, hydroquinone, resorcinol, naphthalene diol, biphenol, bisphenol and xylilene glycol.

In the preferred embodiment of the invention, the second glycol is aliphatic alkane diol having from 2 to 6 carbon atoms such as trimethylene glycol, propylene glycol and/or hexane diol, and/or polyoxyalkylene glycol having an oxyalkylene unit at a repeat number of about 2 to 4 such as diethylene glycol.

Preferably, terephthalic acid in the poly(ethylene terephthalate) may be replaced by the second dicarboxylic acid, the second dicarboxylic acid, for example isophthalic acid, naphthalenedicarboxylic acid, is preferably in an amount of up to 10 mol %, based on the total moles of terephthalic acid and the second dicarboxylic acid. Ethylene glycol in the poly(ethylene terephthalate) may also be replaced by the second glycol, the second glycol, for example 1,6- hexanediol and/or 5-methyl-1,5-pentanediol, is preferably in an amount of up to 0.75% by weight, based on the total weight of poly(ethylene terephthalate).

Poly(Butylene Naphthalate) (PBN):

In one further preferred embodiment of the invention, poly(butylene naphthalate) (PBN), as component b), is not particularly limited to a specific one as long as a main repeating unit thereof contains a butylene naphthalate formed from 1,4-butanediol and a naphthalenedicarboxylic acid (e.g., 2,6-naphthalenedicarboxylic acid). The PBN may be a poly(butylene naphthalate) homopolymer (a PBN homopolymer) or a poly(butylene naphthalate) copolymer (a PBN copolymer), which is a copolymer of butylene naphthalate component and a third component. The third component (copolymerizable component) may be any one of a dicarboxylic acid component, a glycol component, and an aromatic diol component. Incidentally, the above-mentioned “main” unit occupies not less than 70% by mol of the total repeating units.

For example, an acid component (a dicarboxylic acid component) as the third component may include an aromatic dicarboxylic acid such as isophthalic acid, phthalic acid, a diphenyldicarboxylic acid, a diphenyletherdicarboxylic acid, a diphenylsulfonedicarboxylic acid, a diphenylketonedicarboxylic acid, sodium-sulfoisophthalic acid, or dibromoterephtbalic acid, an aliphatic dicarboxylic acid such as malonic acid, succinic acid, adipic acid, azelaic acid, sebacic acid, or decanedicarboxylic acid, and an alicyclic dicarboxylic acid such as cyclohexanedicarboxylic acid, decalindicarboxylic acid, hexahydroterephthalic acid. These acid components may be an ester-bond-formable derivative (or an ester-bond-forming derivative). The term “ester-bond-formable derivative” or “ester-bond-forming derivative” means a compound which easily forms an ester bond by a chemical reaction. Concrete examples of such a derivative include an acid halide, a lower alkyl ester, or a lower aromatic ester, and others. These dicarboxylic acid components may be used alone or in combination.

The glycol component as the third component may include an aliphatic diol component (for example, an alkylene glycol such as ethylene glycol, propylene glycol, trimethylene glycol, or hexamethylene glycol, and a (poly)oxyalkylene glycol such as diethylene glycol, triethylene glycol, a polyethylene glycol, or a poly(tetramethylene glycol)), an alicyclic diol component [for example, cyclohexanediol and cyclohexanedimethanol) an aromatic diol component (for example, an alkylene oxide adduct of a bisphenol compound, such as 2,2-bis(4-(2-hydroxyethoxy)phenyl)propane), and others.

Moreover, the third component may include an aliphatic hydroxycarboxylic acid component (for example, glycolic acid, hydroacrylic acid, and 3-oxypropionic acid), an alicyclic hydroxycarboxylic acid component (for example, asiatic acid and quinovatic acid), and an aromatic hydroxycarboxylic acid component (for example, salicylic acid, m-hydroxybenzoic acid, p-hydroxybenzoic acid, mandelic acid, and atrolactic acid). These components may be used alone or in combination.

Further, the aromatic diol component may include, for example, hydroquinone, catechol, naphthalenediol, resorcin, 4,4′-dihydroxy-diphenylsulfone, bisphenol A (2,2′-bis(4-hydroxyphenyl)propane), and tetrabromobisphenol A. These components may also be used alone or in combination.

The PBN (a PBN homopolymer or a PBN copolymer) may be produced by a conventionally known process for producing a poly(butylene naphthalate). For example, the PBN may be produced by an esterification among a naphthalenedicarboxylic acid (e.g., 2,6-naphthalenedicarboxylic acid), 1,4-butanediol and an optional third component or a transesterification among a lower alkyl ester of a naphthalenedicarboxylic acid (e.g., a dimethyl ester), 1,4-butanediol and an optional third component.

The number-average molar mass molecular weight (Mn) of poly(butylene naphthalate) (PBN) is generally in the range from 5,000 to 50,000 g/mol, preferably from 8,000 to 20,000 g/mol, measured by means of GPC.

Poly(Ethylene Naphthalate) (PEN):

In one further preferred embodiment of the invention, poly(ethylene naphthalate) (PEN) is a polyester produced when dimethyl 2,6-naphthalene dicarboxylate (NDC) or 2,6-naphthalene dicarboxylic acid (2,6-NDA) is reacted with ethylene glycol. The PEN polymer comprises repeating units of ethylene 2,6-naphthalate. PEN polymers may optionally be modified with various materials such as dicarboxylic acids, glycols, cyclohexanes, xylenes and bases appropriate for polyester formation. Such modifying materials are typically precompounded with the PEN. Thus, as used herein PEN is meant to include such modified polymers.

When dicarboxylic acids are used as the modifying materials, the PEN may include up to 15 mol %, and preferably up to 10 mol %, of one or more of the dicarboxylic acids containing 2 to 36 carbon atoms other than naphthalene dicarboxylic acid isomer(s), and/or one or more glycols containing 2 to 12 carbon atoms different than ethylene glycol.

Typical modifying dicarboxylic acids for PEN include terephthalic, isophthalic, adipic, glutaric, azelaic, sebacic, fumaric and stilbene dicarboxylic acid and the like. Typical examples of a modifying glycol for PEN include 1,4-butanediol, 1,6-hexanediol, 2,2-dimethyl-1,3-propanediol, 1,4-cyclohexanedimethanol, and the like. The PEN polymers are preferably derived from 2,6-naphthalenedicarboxylic acid, but may be derived from 2,6-naphthalene-dicarboxylic acid and also contain, optionally, up to about 25 mol % (preferably up to 15 mol %, more preferably up to 10 mol %) of one or more residues of different naphthalene dicarboxylic acid isomers such as the 1,2-, 1,3-, 1,4-, 1,5-, 1,6-, 1,7-, 1,8-, 2,3-, 2,4-, 2,5-, 2,7- or 2,8-isomers. PEN polymers primarily modified with 1,4-, 1,5-, or 2,7-naphthalenedicarboxylic acid are also useful.

Typical glycols used for modifying PEN include but are not limited to alkylene glycols, such as propylene glycol, butylene glycol, pentylene glycol, 1,6-hexanediol, and 2,2-dimethyl-1,3-propanediol.

The number-average molar mass molecular weight (Mn) of poly(ethylene naphthalate) (PEN) is generally in the range from 5,000 to 50,000 g/mol, preferably from 8,000 to 30,000 g/mol, measured by means of GPC.

Additional Components:

The PBT-based composition according to the invention comprises, as additional component, preferably from 0.1 to 1.5% by weight, and in particular from 0.3 to 1.2% by weight, of epoxy-functionalized compatibilizer, based on the total weight of the PBT-based composition.

In one preferred embodiment, the PBT-based composition comprises a) PBT, b) the polyester selected from LCP, PEN and PBN, and 0.3 to 1.2% by weight of epoxy-functionalized compatibilizer.

In another preferred embodiment, the PBT-based composition comprises 55-65% by weight of PBT, 35 to 45% by weight of the polyester, and 0.3 to 1.2% by weight of epoxy-functionalized compatibilizer, the polyester is PEN, PBN and/or LCP, preferably is PEN and/or LCP.

As additional component, the epoxy-functionalized compatibilizer comprises at least two epoxy groups and aromatic and/or aliphatic segments as well as non-epoxy functional groups, which is made from the polymerization of at least one epoxy-functional (meth)acrylic monomers and non-functional (meth)acrylic acid and/or styrenic monomers. As used herein, the term (meth)acrylic monomers include both acrylic and methacrylic monomers. Examples of epoxy-functional (meth)acrylic monomers for use in the present invention include both acrylates and methacrylates. Examples of these monomers include, but are not limited to, those containing 1,2-epoxy groups such as glycidyl acrylate and glycidyl methacrylate. Other suitable epoxy-functional monomers include allyl glycidyl ether, glycidyl ethacrylate, and glycidyl itaconate.

Suitable non-functional acrylate and methacrylate monomers for use in the epoxy-functionalized compatibilizer include, but are not limited to, methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, n-hexyl acrylate, 2-ethylbutyl acrylate, isobornyl acrylate, n-octyl acrylate, 2-ethylhexyl acrylate, n-decyl acrylate, cyclopentyl acrylate, cyclohexyl acrylate, methylcyclohexyl acrylate, methyl methacrylate, ethyl methacrylate, n-propyl methacrylate, i-propyl methacrylate, n-butyl methacrylate, s-butyl-methacrylate, i-butyl methacrylate, t-butyl methacrylate, n-amyl methacrylate, i-amyl methacrylate, n-hexyl methacrylate, 2-ethylbutyl methacrylate, methylcyclohexyl methacrylate, cinnamyl methacrylate, crotyl methacrylate, cyclopentyl methacrylate, cyclohexyl methacrylate, 2-ethoxyethyl methacrylate, and isobornyl methacrylate. Non-functional acrylate and non-functional methacrylate monomers including methyl methacrylate, n-butyl acrylate, n-butyl methacrylate, i-butyl methacrylate, cyclohexyl acrylate, cyclohexyl methacrylate, isobornyl acrylate and isobornyl methacrylate and combinations thereof are particularly suitable. Styrenic monomers for use in the present invention include, but are not limited to, styrene, alpha-methyl styrene, vinyl toluene, p-methyl styrene, t-butyl styrene, o-chlorostyrene, and mixtures thereof. In certain embodiments the styrenic monomers for use in the present invention are styrene and alpha-methyl styrene.

In one embodiment of the invention, the epoxy-functionalized compatibilizer contains about 50% to about 80% by weight, based on the total weight of the monomers, of at least one epoxy-functional (meth)acrylic monomer and between about 20% and about 50% by weight of at least one styrenic monomer. In other embodiments, the epoxy-functionalized compatibilizer contains between about 25% and about 50% by weight of at least one epoxy-functional (meth)acrylic monomer, between about 15% to about 30% by weight of at least one styrenic monomer, and between about 20% and about 60% by weight of at least one non-functional acrylate and/or methacrylate monomer. In yet another embodiment of the invention, the epoxy-functionalized compatibilizer contains about 50% to about 80% by weight, based on the total weight of the monomers, of at least one epoxy-functional (meth)acrylic monomer and between about 15% and about 45% by weight of at least one styrenic monomer and between about 0% to about 5% by weight of at least one non-functional acrylate and/or methacrylate monomer. In still another embodiment, the epoxy-functionalized compatibilizer contains between about 5% and about 25% by weight of at least one epoxy-functional (meth)acrylic monomer, between about 50% to about 95% by weight of at least one styrenic monomer, and between about 0% and about 25% by weight of at least one non-functional acrylate and/or methacrylate monomer.

More specifically, the epoxy-functionalized compatibilizer has an epoxy equivalent weight of from 150 to 3,500 g/Eq, preferably from 180 to 2,800 g/Eq, and in particular from 220 to 1,800 g/Eq, number average epoxy functionality of less than 50, preferably less than 30, and in particular less than 20, weight average epoxy functionality of up to 200, preferably up to 140, and in particular up to 100, and Mw in the range from 2,800 to 12,000 g/mol, preferably from 3,500 to 9,000 g/mol, and in particular from 4,500 to 8,500 g/mol. The epoxy-functionalized compatibilizer may be Joncryl® ADR 4368 (Referring to BASF patent US20040138381).

The epoxy-functionalized compatibilizer may be produced according to standard techniques well known in the art. Such techniques include, but are not limited to, continuous bulk polymerization processes, batch, and semi-batch polymerization processes. Production techniques that are well suited for the epoxy-functionalized compatibilizer are described in U.S. patent application Ser. No. 09/354,350 and U.S. patent application Ser. No. 09/614,402, the entire disclosures of which are incorporated herein by reference. Briefly, these processes involve continuously charging into a reactor at least one epoxy-functional (meth)acrylic monomer, at least one styrenic and/or (meth)acrylic monomer, and optionally one or more other monomers that are polymerizable with the epoxy-functional monomer, the styrenic monomer, and/or the (meth)acrylic monomer.

The proportion of monomers charged into the reactor may be the same as those proportions that go into the epoxy-functionalized compatibilizer discussed above. Thus, in some embodiments, the reactor may be charged with about 50% to about 80%, by weight, of at least one epoxy-functional (meth)acrylic monomer and with about 20% to about 50%, by weight, of at least one styrenic and/or (meth)acrylic monomer. Alternatively, the reactor may be charged with from about 25% to about 50%, by weight, of at least one epoxy-functional (meth)acrylic monomer and with about 50% to about 75%, by weight, of at least one styrenic and/or (meth)acrylic monomer. In other embodiments the reactor may be charged with from about 5% to about 25%, be weight, of at least one epoxy-functional (meth)acrylic monomer and with about 75% to about 95%, by weight, of at least one styrenic and/or (meth)acrylic monomer.

The reactor may also optionally be charged with at least one free radical polymerization initiator and/or one or more solvents. Examples of suitable initiators and solvents are provided in U.S. patent application Ser. No. 09/354,350. Briefly, the initiators suitable for carrying out the process according to the present invention are compounds which decompose thermally into radicals in a first order reaction, although this is not a critical factor. Suitable initiators include those with half-life periods in the radical decomposition process of about 1 hour at temperatures greater or equal to 90° C. and further include those with half-life periods in the radical decomposition process of about 10 hours at temperatures greater or equal to 100° C. Others with about 10 hours half-lives at temperatures significantly lower than 100° C. may also be used. Suitable initiators are, for example, aliphatic azo compounds such as 1-t-amylazo-1-cyanocyclohexane, azo-bis-isobutyronitrile and 1-t-butylazo-cyanocyclohexane, 2,2′-azo-bis-(2-methyl)butyronitrile and peroxides and hydroperoxides, such as t-butylperoctoate, t-butyl perbenzoate, dicumyl peroxide, di-t-butyl peroxide, t-butyl hydroperoxide, cumene hydroperoxide, di-t-amyl peroxide and the like. Additionally, di-peroxide initiators may be used alone or in combination with other initiators. Such di-peroxide initiators include, but are not limited to, 1,4-bis-(t-butyl peroxycarbo)cyclohexane, 1,2-di(t-butyl peroxy)cyclohexane, and 2,5-di(t-butyl peroxy)hexyne-3, and other similar initiators well known in the art. The initiators di-t-butyl peroxide and di-t-amyl peroxide are particularly suited for use in the invention.

The initiator may be added with the monomers. The initiators may be added in any appropriate amount, but preferably the total initiators are added in an amount of about 0.0005 to about 0.06 moles initiator(s) per mole of monomers in the feed. For this purpose, initiator is either admixed with the monomer feed or added to the process as a separate feed.

The solvent may be fed into the reactor together with the monomers, or in a separate feed. The solvent may be any solvent well known in the art, including those that do not react with the epoxy functionality on the epoxy-functional (meth)acrylic monomer(s) at the high temperatures of the continuous process described herein. The proper selection of solvent may help to decrease or eliminate the gel particle formation during the continuous, high temperature reaction of the present invention. Such solvents include, but are not limited to, xylene, toluene, ethyl-benzene, Aromatic-100®, Aromatic 150®, Aromatic 200® (all Aromatics available from Exxon), acetone, methylethyl ketone, methyl amyl ketone, methyl-isobutyl ketone, n-methyl pyrrolidinone, and combinations thereof. When used, the solvents are present in any amount desired, taking into account reactor conditions and monomer feed. In one embodiment, one or more solvents are present in an amount of up to 40% by weight, up to 15% by weight in a certain embodiment, based on the total weight of the monomers.

The reactor is maintained at an effective temperature for an effective period of time to cause polymerization of the monomers.

A continuous polymerization process allows for a short residence time within the reactor. The residence time is generally less than one hour, and may be less than 15 minutes. In some embodiments, the residence time is generally less than 30 minutes, and may be less than 20 minutes.

The process for producing the epoxy-functionalized compatibilizer may be conducted using any type of reactor well-known in the art, and may be set up in a continuous configuration. Such reactors include, but are not limited to, continuous stirred tank reactors (CSTRs), tube reactors, loop reactors, extruder reactors, or any reactor suitable for continuous operation.

A form of CSTR which has been found suitable for producing the epoxy-functionalized compatibilizer is a tank reactor provided with cooling coils and/or cooling jackets sufficient to remove any heat of polymerization not taken up by raising the temperature of the continuously charged monomer composition so as to maintain a preselected temperature for polymerization therein. Such a CSTR may be provided with at least one, and usually more, agitators to provide a well-mixed reaction zone. Such CSTR may be operated at varying filling levels from 20 to 100% full (liquid full reactor LFR). In one embodiment the reactor is more than 50% full but less than 100% full. In another embodiment the reactor is 100% liquid full.

The continuous polymerization is carried out at high temperatures. In one embodiment, the polymerization temperatures range from about 180 to about 350° C., this includes embodiments where the temperatures range from about 190 to about 325° C., and more further includes embodiment where the temperatures range from about 200 to about 300° C. In another embodiment, the temperature may range from about 200 to about 275° C.

Customary Additives:

The PBT-based composition according to the invention can further comprise the other constituents being additives selected by those skilled in the art in accordance with the later use of the products, preferably from at least one of customary additives defined hereinafter, provided that said customary additives don't have negative effect on the PBT-based composition according to the invention.

Customary additives used according to the invention are preferably stabilizers, demolding agents, UV stabilizers, thermal stabilizers, gamma ray stabilizers, antistats, flow aids, flame retardants, elastomer modifiers, acid scavengers, emulsifiers, nucleating agents, plasticizers, lubricants, dyes or pigments. These and further suitable additives are described, for example, in Gächter, Müller, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives can be used alone or in a mixture, or in the form of masterbatches.

The PBT-based composition comprises preferably 0 to 5% by weight of the customary additives, more preferably is 0.1 to 2% by weight.

Stabilizers used are preferably sterically hindered phenols or phosphites, hydroquinones, aromatic secondary amines such as diphenylamines, substituted resorcinols, salicylates, benzotriazoles and benzophenones, and also variously substituted representatives of these groups or mixtures thereof.

Preferred phosphites are selected from the group of tris(2,4-di-tert-butylphenyl) phosphite (Irgafos®168, BASF SE, CAS 31570-04-4), bis(2,4-di-tert-butylphenyl)pentaerythrityl diphosphite (Ultranox® 626, Chemtura, CAS 26741-53-7), bis(2,6-di-tert-butyl-4-methylphenyl)pentaerythrityl diphosphite (ADK Stab PEP-36, Adeka, CAS 80693-00-1), bis(2,4-dicumylphenyl)pentaerythrityl diphosphite (Doverphos® S-9228, Dover Chemical Corporation, CAS 154862-43-8), tris(nonylphenyl) phosphite (Irgafos® TNPP, BASF SE, CAS 26523-78-4), (2,4,6-tri-t-butylphenol)-2-butyl-2-ethyl-1,3-propanediol phosphite (Ultranox®641, Chemtura, CAS 161717-32-4) and Hostanox® P-EPQ.

The phosphite stabilizer used is especially preferably at least Hostanox® P-EPQ (CAS No. 119345-01-6) from Clariant International Ltd., Muttenz, Switzerland. This comprises tetrakis(2,4-di-tert-butylphenyl)-1,1-biphenyl-4,4′-diyl bisphosphonite (CAS No. 38813-77-3), which can especially be used with very particular preference in accordance with the invention.

Acid scavengers used are preferably hydrotalcite, chalk, zinc stannate or boehmite.

Preferred demolding agents used are at least one selected from the group of ester wax(es), pentaerythrityl tetrastearate (PETS), long-chain fatty acids, salt(s) of the long-chain fatty acids, amide derivative(s) of the long-chain fatty acids, montan waxes and low molecular weight polyethylene or polypropylene wax(es), and ethylene homopolymer wax(es). If included, the demolding agent is preferably present in an amount of about 0.01 to 5 wt %, more preferably of about 0.01 to 3 wt %, and most preferably of about 0.01 to 2 wt %, each based on the total weight of the PBT-based composition according to the invention.

Preferred long-chain fatty acids are stearic acid or behenic acid. Preferred salts of long-chain fatty acids are calcium stearate or zinc stearate. A preferred amide derivative of long-chain fatty acids is ethylenebisstearylamide (CAS No. 130-10-5). Preferred montan waxes are mixtures of short-chain saturated carboxylic acids having chain lengths of 28 to 32 carbon atoms.

Nucleating agents used are preferably sodium phenylphosphinate or calcium phenylphosphinate, alumina (CAS No. 1344-28-1) or silicon dioxide.

Plasticizers used are preferably dioctyl phthalate, dibenzyl phthalate, butyl benzyl phthalate, hydrocarbon oils or N-(n-butyl)benzenesulphonamide.

In one embodiment of the present invention, the PBT-based composition according to the invention comprises alkali metal carbonate salt or alkali metal bicarbonate salt or their mixture, selected from the group consisting of sodium carbonate, lithium carbonate, potassium carbonate, calcium carbonate, sodium bicarbonate, lithium bicarbonate, potassium bicarbonate, calcium bicarbonate, and combination thereof. Preferably, the PBT-based composition according to the invention comprises sodium carbonate, potassium carbonate, lithium carbonate, sodium bicarbonate, potassium bicarbonate, lithium bicarbonate, and combination thereof.

The alkali metal carbonate salt or alkali metal bicarbonate salt or their mixture is preferably present in an amount of about 0.05 to 2 wt %, and more preferably of about 0.05 to 1 wt %, based on the PBT-based composition according to the invention.

In another aspect, the present invention provides a method for preparing a package or housing of battery cell, comprising: (1) injection molding a main body of the package or housing having at least one wall and one bottom, and a cap or cover, (2) binding the main body with the cap or the cover by laser welding.

The Preparation of the PBT-Based Composition:

In another aspect, the present invention relates to a method for preparing the PBT-based composition according to the invention by mixing all components

The preparation of the PBT-based composition according to the present invention for further use or application takes place by mixing components a), and b) to be used as educts in at least one mixing tool. Blends are obtained as intermediate products and based on the PBT-based composition according to the present invention. These blends can exist either exclusively of the components a), and b), or include, however, in addition, to the components a), and b) even other components and also the above additives. In the former case the components a), and b) are to be varied within the scope of the given amount areas in such way that the sum of all weight percent always results in 100.

The process for the preparation of the blends is described as followed: (1) PBT and another thermoplastic polymer were dried at 120 to 150° C. under 1 to 2 hours, controlling the moisture <0.05%; (2) the typical range of the compositions: PBT resin, another thermoplastic polymer such as PP, LCP, PBN, PEN, PET etc., and/or epoxy-functionalized compatibilizer, and/or alkali metal carbonate, were added to a twin-screw extruder, pelletized and dried, to obtain the blends; (3) the processing conditions in step (2): processing temperatures in the range of 280 to 300° C., screw speed of 200 to 400 rpm, residence time of 1 to 3 minutes. The above additives can be incorporated during or after the preparation of the blends.

In another aspect, the present invention provides a method of improving electrolyte resistance, comprising applying the PBT-based composition to battery components, especially Li-ion battery components. The battery component is preferably selected from the group consisting of package, housing, main body of package or housing, cover, cap and busbar of battery cell, battery module and battery pack.

In another aspect, the present invention also provides a PBT-based composition, comprising a) PBT, and b) another thermoplastic polymer.

In another aspect, the present invention provides a use of the PBT-based composition according to the invention in increasing electrolyte resistance, in particular in the battery components. The battery component is preferably selected from the group consisting of package, housing, main body of package or housing, cover, cap and busbar of battery cell, battery module and battery pack. The battery is preferably Li-ion battery.

The examples given below are intended to illustrate the invention without restricting it.

### Examples

Component a):

Ultradur® B 1950 from BASF (PBT with viscosity number to ISO307,1157,1628 of 90 cm³/g, number-average molar mass molecular weight (Mn) of 15,800 g/mol)

Ultradur® B 2550 from BASF (PBT with viscosity number to ISO307,1157,1628 of 107 cm³/g, number-average molar mass molecular weight (Mn) of 16,500 g/mol)

Ultradur® B4500 from BASF (PBT with viscosity number to ISO307,1157,1628 of 130 cm³/g, number-average molar mass molecular weight (Mn) of 23,200 g/mol)

Component b):

PET from Wankai WK-851, with Tm=243° C.

PP from Sinopec F401 (number-average molar mass molecular weight (Mn) of 43,000 g/mol, having 1,2,4-trichlorobenzene as eluent)

GMA-grafted PP from Fulsolution Materials Technology (number-average molar mass molecular weight (Mn) of 44,500 g/mol, having 1,2,4-Trichlorobenzene as eluent)

PEN from Teijin Teonex TN-8065s

PBN from Teijin Teonex TQB-OT

LCP from WOTE Selcoin KE

Additional Component:

Joncryl® ADR 4368 from BASF (Mw=6,800 g/mol, epoxide equivalent weight 280 g/Eq, branched epoxy-functionalized compatibilizer)

Customary Additives:

Loxiol P861 from Emery Oleochemicals (pentaerythrityl tetrastearate)

Characterization:

Tensile strength, strain at break, strain at yield and E-modulus are measured and characterized on Z050 (Zwick Roell, Germany), according to ISO 527-2 using test specimens having the shape of type 5A.

Tg of the polymers is measured in TA Discovery DSC with N₂ purge at the rate of 20 K per min from 0° C. to 300° C.

Electrolyte resistance test is done via immersing dumbbell-shaped specimens of different materials into the electrolyte solutions, which contain the mixtures of ethyl methyl carbonate (EMC), diethyl carbonate (DEC) and ethylene carbonate (EC) (EMC:DEC:EC=1:1:1) with 1 mol/L LiPFs, at 85° C. for 240 hours in the autoclave. After the specimens are cleaned by ethanol and then dried in the oven for overnight, mechanical properties including tensile strength and E-modulus are measured on Z050 (Zwick Roell, Germany) according to ISO 527-2. The retention of mechanical properties is characterized by the change of mechanical properties before/after electrolyte immersion test.

Laser weldability of the specimens is tested by contour welding with welding speed of 500 mm/s, welding time of 2 seconds and laser transmission of 980 nm in LPKF welding machine. A “Yes” to laser weldability means the specimens with the thickness of 1.5 mm can be welded at the maximal welding power of 220 Watt.

The preparations of the PBT-based composition according to the invention from the following ingredients in Table 1 are described as followed:

(1) PBT and another thermoplastic polymer were dried at 120° C. under 2 hours, controlling the moisture <0.05%;

(2) the typical range of the composition: PBT resin, another thermoplastic polymer such as PP, LCP, PBN, PEN, PET etc., and/or epoxy-functionalized compatibilizer, and/or alkali metal carbonate and additives, were added to a twin-screw extruder in the range of 280 to 300° C., pelletized and dried, to obtain the blends.

Seen from Table 1, the PBT-based composition could keep the good mechanical properties after the electrolyte resistance test.

TABLE 1

| Component (wt %) | | CE1 | CE2 | CE3 | CE4 | E1 | E2 | E3 | E4 | E5 | E6 | E7 | E8 | E9 | E10 | E11 |
|---|---|---|---|---|---|---|---|---|---|---|---|---|---|---|---|---|
| PBT B1950 | | 99.6 | | | | | | | 59.6 | | | | | | | |
| PBT B2550 | | | 99.6 | | | 59.6 | | | | | | | | | | |
| PBT B4500 | | | | 99.6 | 69.6 | | 59.1 | 79.6 | | 59.6 | 58.6 | 79.6 | 59.6 | 78.6 | 58.6 | 59.6 |
| PET | | | | | | | | | | | | | | | | 40 |
| PP | | | | | 30 | 30 | 30 | | | | | | | | | |
| PEN | | | | | | | | 20 | 40 | 40 | 40 | | | | | |
| PBN | | | | | | | | | | | | 20 | 40 | | | |
| LCP | | | | | | | | | | | | | | 20 | 40 | |
| GMA-grafted PP | | | | | | 10 | 10 | | | | | | | | | |
| Na₂CO₃ | | | | | | | 0.5 | | | | 0.5 | | | | | |
| Joncryl AD4368 | | | | | | | | | | | 0.5 | | | 1 | 1 | |
| Loxiol P861 | | 0.4 | 0.4 | 0.4 | 0.4 | 0.4 | 0.4 | 0.4 | 0.4 | 0.4 | 0.4 | 0.4 | 0.4 | 0.4 | 0.4 | 0.4 |
| Total (wt %) | | 100 | 100 | 100 | 100 | 100 | 100 | 100 | 100 | 100 | 100 | 100 | 100 | 100 | 100 | 100 |
| Before | Tensile Strength (MPa) | 60 | 58.7 | 56.8 | 43.8 | 46.3 | 48 | 61.5 | 64.1 | 59.5 | 49.4 | 60 | 61.8 | 69.8 | 50.3 | 63.7 |
| electrolyte | Strain at yield (%) | 4.4 | 8.5 | 3.2 | 3.4 | 7.9 | 5.9 | 5.2 | — | — | — | 7.4 | 7.6 | — | — | 3.5 |
| testing | Strain at break (%) | 13.4 | 19.5 | 22.4 | 5.8 | 15.6 | 6.5 | 9.7 | 4.1 | 3.2 | 2.3 | 12.4 | 15.1 | 3.6 | 1.3 | 8.1 |
| | E-Modulus (MPa) | 2600 | 2550 | 2560 | 2220 | 2210 | 2320 | 2600 | 2480 | 2320 | 2430 | 2490 | 2350 | 3470 | 4450 | 2800 |
| After | Tensile Strength (MPa) | 43 | 41 | 45 | 34 | 37.7 | 40.5 | 46.6 | 51.3 | 59 | 46.2 | 49.3 | 54.8 | 51.9 | 50.1 | 52.7 |
| electrolyte | Strain at yield (%) | 14.7 | 14.7 | 13.6 | 9.1 | 12.6 | 10.8 | — | — | — | — | — | 10.4 | 4.3 | — | 9.2 |
| testing | Strain at break (%) | 17.6 | 65.4 | 52.2 | 14.6 | 31.1 | 14.2 | 4.3 | 3.9 | 4.1 | 2.3 | 9.3 | 89 | 5.4 | 1.4 | 41.5 |
| | E-Modulus (MPa) | 1060 | 918 | 1290 | 1100 | 1050 | 1260 | 1820 | 1900 | 2150 | 2170 | 1570 | 1910 | 2360 | 4100 | 1950 |
| Mechanical | Tensile Strength (%) | 71.7 | 69.9 | 79.2 | 77.6 | 81.4 | 84.4 | 77.9 | 80 | 99.2 | 93.5 | 82.2 | 88.7 | 74.4 | 99.6 | 82.7 |
| properties Re- | E-Modulus (%) | 40.8 | 36 | 50.4 | 49.6 | 47.5 | 54.3 | 70 | 76.6 | 92.7 | 89.3 | 63.1 | 81.3 | 68 | 92.1 | 69.6 |
| tention | | | | | | | | | | | | | | | | |
| Laser | Tested by LPKF | Yes | Yes | Yes | Yes | Yes | Yes | Yes | Yes | Yes | Yes | Yes | Yes | No | No | Yes |
| weldability | welding machine | | | | | | | | | | | | | | | |

1. An article as a battery component, which is obtained from a poly(butylene terephthalate)-based composition comprising a) poly(butylene terephthalate), and b) another thermoplastic polymer.

2. The article according to claim 1, wherein the article is selected from the group consisting of package, housing, main body of package or housing, cover, cap and busbar of battery cell, battery module, and battery pack.

3. The article according to claim 1, wherein the poly(butylene terephthalate)-based composition comprises a) from 45% to 85% by weight of poly(butylene terephthalate), and b) from 15% to 55% by weight of another thermoplastic polymer, based on the total weight of the PBT-based composition.

4. The article according to claim 1, wherein component a) is butylene terephthalate homopolymer or a polymer that is modified with up to 20 mol % of one or more dicarboxylic acids other than terephthalic acid and/or one or more glycol other than 1,4-butanediol.

5. The article according to claim 1, wherein component b) is polypropylene, and/or at least one polyester which has a glass transition temperature of equal to or higher than 45° C. measured by DSC.

6. The article according to claim 1, wherein the poly(butylene terephthalate)-based composition comprises a) from 50% to 80% by weight of poly(butylene terephthalate), and b) from 20% to 50% by weight of another thermoplastic polymer, based on the total weight of the poly(butylene terephthalate)-based composition.

7. The article according to claim 1, wherein the poly(butylene terephthalate)-based composition comprises 55% to 65% by weight of component a), and 35% to 45% by weight of another thermoplastic polymer b), and is a polyester selected from the group consisting of poly(ethylene naphthalate), liquid crystal polyester, poly(butylene naphthalate), and poly(ethylene terephthalate).

8. The article according to claim 1, wherein the poly(butylene terephthalate)-based composition comprises a) from 45% to 85% by weight of poly(butylene terephthalate), and b1) from 10% to 40% by weight of ungrafted polypropylene homopolymers, copolymers or blends, and b2) from 5% to 20% by weight of polypropylene copolymers grafted with ethylenically unsaturated carboxylic acid and/or ester and/or acid anhydride thereof, based on the total weight of the poly(butylene terephthalate)-based composition.

9. The article according to claim 8, wherein the polypropylene copolymer b2) is polypropylene grafted with ethylenically unsaturated carboxylic acid of up to 15 carbon atoms, ester and/or acid anhydride thereof.

10. The article according to claim 1, wherein the poly(butylene terephthalate)-based composition comprises epoxy-functionalized compatibilizer as additional component which comprises at least two epoxy groups and aromatic and/or aliphatic segments as well as non-epoxy functional groups, which is made from the polymerization of at least one epoxy-functional (meth)acrylic monomers and non-functional (meth)acrylic acid and/or styrenic monomers.

11. The article according to claim 10, wherein the additional component has an epoxy equivalent weight of from 150 to 3,500 g/Eq, number average epoxy functionality of less than 50, weight average epoxy functionality of up to 200, and Mw in the range from 2,800 to 12,000 g/mol.

12. The article according to claim 10, wherein the poly(butylene terephthalate)-based composition comprises 0.1% to 1.5% by weight of epoxy-functionalized compatibilizer, based on the total weight of the poly(butylene terephthalate)-based composition.

13. The article according to claim 10, wherein the poly(butylene terephthalate)-based composition comprises a) poly(butylene terephthalate), b) the polyester selected from liquid crystal polyester, poly(ethylene naphthalate) and poly(butylene naphthalate), and 0.3% to 1.2% by weight of epoxy-functionalized compatibilizer.

14. The article according to claim 10, wherein the poly(butylene terephthalate)-based composition comprises 55%-65% by weight of poly(butylene terephthalate), 35% to 45% by weight of the polyester, and 0.3% to 1.2% by weight of epoxy-functionalized compatibilizer, wherein the polyester is poly(ethylene naphthalate), poly(butylene naphthalate), and/or liquid crystal polyester.

15. The article according to claim 1, wherein the poly(butylene terephthalate)-based composition further comprises at least one of additives selected from the group consisting of stabilizers, demolding agents, UV stabilizers, thermal stabilizers, gamma ray stabilizers, antistats, flow aids, flame retardants, elastomer modifiers, acid scavengers, emulsifiers, nucleating agents, plasticizers, lubricants, dyes, and pigments.

16. A method of improving electrolysis resistance, comprising applying the poly(butylene terephthalate)-based composition as defined in claim 1 to a battery component.

17. A poly(butylene terephthalate)-based composition as defined in claim 1, comprising a) poly(butylene terephthalate), and b) another thermoplastic polymer.

18. (canceled)

19. A method for preparing a package or housing of battery cell as defined in claim 1, comprising: (1) injection molding a main body of the package or housing having walls and one bottom, and a cap or a cover, respectively (2) binding the main body with the cap or the cover by laser welding.

20. The article according to claim 5 wherein the polyester has a melting point of equal to or higher than 220° C. as measured by DSC.

21. The article according to claim 5 wherein the polyester is selected from liquid crystal polyester, poly(ethylene terephthalate), poly(butylene naphthalate), and poly(ethylene naphthalate).

22. The article according to claim 9 wherein the ethylenically unsaturated carboxylic acid is glycidyl methacrylate, acrylic acid, methacrylic acid, methyl acrylate, methyl methacrylate, 2-hydroxypropyl methacrylate, butyl acrylate, and maleic anhydride

23. The method of claim 16 wherein the battery component is a Li-ion battery component.
